(19) United States
(12) Patent Application Publication
(10) Pub. No.: US 2026/0064167 A1
(43) Pub. Date: Mar. 5, 2026

(54) DETACHABLE FRONT FRAME STRUCTURE AND MONITOR APPARATUS THEREOF

(71) Applicant: QISDA CORPORATION, Taoyuan City (TW)

(72) Inventor: Hsin-Tzu Liu, Taoyuan City (TW)

(73) Assignee: QISDA CORPORATION, Taoyuan City (TW)

(21) Appl. No.: 19/238,567

(22) Filed: Jun. 16, 2025

(30) Foreign Application Priority Data
Aug. 30, 2024 (CN) 202411207239.6

(51) Int. Cl. G06F 1/18; G06F 3/042; G06F 3/14

(52) U.S. Cl. CPC G06F 1/181; G06F 3/042; G06F 3/1446

(57) ABSTRACT

A detachable front frame structure includes a front frame detachably disposed on a monitor and having first outer and inner walls, an optical touch module disposed within the front frame, and a film component. A side of the front frame pivots away from or close to the monitor. The film component between the front frame and the monitor includes a film and a film frame surrounding the film and having second outer and inner walls. A side of the film frame is detachably connected to another side of the front frame. When the film frame slides into the front frame and the front frame pivots toward the monitor, the first outer and inner walls interfere with chamfer structures of the second outer and inner walls to make the first outer wall enter between the second outer and inner walls to slide the film frame outward for pulling the film tightly.

### BACKGROUND OF THE INVENTION

### 1. Field of the Invention

The present invention relates to a detachable front frame structure and a monitor apparatus thereof, and more specifically, to a detachable front frame structure utilizing sliding interference between walls of a film frame and a front frame to allow a film accommodated in the film frame to slide into or be extracted from the front frame and a monitor apparatus thereof.

### 2. Description of the Prior Art

In general, a large monitor apparatus on the market are formed by splicing fixed-size screens together, with shafts mounted between the fixed-size screens to make them pivotable, thereby providing a monitor bending function. On the other hand, to enhance the functionality of the large monitor apparatus, an optical touch module is usually mounted in the front frame, and a film is applied over an entire display surface of the large monitor apparatus to eliminate gaps between the fixed-size screens. This allows a user to perform optical touch operations on the film, thereby providing a touch function.

However, in the above design, if one of the fixed-size screens needs to be repaired or replaced, the user must completely remove the front frame and tear off the film before the one of the fixed-size screens can be repaired or replaced. This makes the repair or replacement process of the large monitor apparatus time-consuming and strenuous. Additionally, if unevenness of the film occurs because the film is not tightly and evenly adhered to the display surface, it can further negatively affect the touch experience of the large monitor apparatus.

### SUMMARY OF THE INVENTION

The present invention provides a detachable front frame structure including a front frame, an optical touch module, and a film component. The front frame is detachably disposed on a monitor and has a first top frame, a first side frame, a first bottom frame, and a first connection frame in sequential connection. The first top frame, the first side frame, and the first bottom frame protrude toward the monitor to form a first outer wall and a first inner wall respectively, and the first top frame and the first bottom frame have at least one shaft respectively to make the first side frame pivotable away from or close to the monitor via the at least one shaft. The optical touch module is accommodated in the first top frame, the first side frame, the first bottom frame and the first connection frame, for establishing a touch sensing area on the monitor. The film component is disposed between the front frame and the monitor. The film component includes a film and a film frame. The film frame has a second top frame, a second side frame, a second bottom frame, and a second connection frame in sequential connection to surround the film. The second connection frame is detachably connected to the first connection frame. The first top frame, the first side frame, and the first bottom frame protrude toward the monitor to respectively form a second outer wall and a second inner wall for defining a limiting slot, and the second outer wall and the second inner wall form a chamfer structure respectively. When the first side frame pivots away from the monitor, the first outer wall of the first top frame and the first outer wall of the first bottom frame slide in the limiting slot, for allowing the film frame to slide into the front frame or be extracted from the front frame. When the film frame slides into the front frame and the first side frame pivots toward the monitor, each first outer wall and each first inner wall respectively slide along the corresponding chamfer structure to a position where each first outer wall enters the limiting slot to slide the film frame outward for pulling the film tightly.

The present invention further provides a monitor apparatus including a monitor and a detachable front frame structure. The detachable front frame structure accommodates the monitor. The detachable front frame structure includes a front frame, an optical touch module, and a film component. The front frame is detachably disposed on the monitor and has a first top frame, a first side frame, a first bottom frame, and a first connection frame in sequential connection. The first top frame, the first side frame, and the first bottom frame protrude toward the monitor to form a first outer wall and a first inner wall respectively, and the first top frame and the first bottom frame have at least one shaft respectively to make the first side frame pivotable away from or close to the monitor via the at least one shaft. The optical touch module is accommodated in the first top frame, the first side frame, the first bottom frame and the first connection frame, for establishing a touch sensing area on the monitor. The film component is disposed between the front frame and the monitor. The film component includes a film and a film frame. The film frame has a second top frame, a second side frame, a second bottom frame, and a second connection frame in sequential connection to surround the film. The second connection frame is detachably connected to the first connection frame. The first top frame, the first side frame, and the first bottom frame protrude toward the monitor to respectively form a second outer wall and a second inner wall for defining a limiting slot, and the second outer wall and the second inner wall form a chamfer structure respectively. When the first side frame pivots away from the monitor, the first outer wall of the first top frame and the first outer wall of the first bottom frame slide in the limiting slot, for allowing the film frame to slide into the front frame or be extracted from the front frame. When the film frame slides into the front frame and the first side frame pivots toward the monitor, each first outer wall and each first inner wall respectively slide along the corresponding chamfer structure to a position where each first outer wall enters the limiting slot to slide the film frame outward for pulling the film tightly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a monitor apparatus according to an embodiment of the present invention.

FIG. 2 is an exploded diagram of the monitor apparatus in FIG. 1.

FIG. 3 is a partially-enlarged diagram of a front frame in FIG. 2.

FIG. 4 is a partially-enlarged diagram of a film frame in FIG. 2.

FIG. 5 is a partial cross-sectional diagram of the monitor apparatus along a cross-sectional line A-A in FIG. 1.

FIG. 6 is a partial cross-sectional diagram of a first side frame pivoting away from a monitor via a shaft in FIG. 5.

FIG. 7 is a partial cross-sectional diagram of the monitor apparatus along a cross-sectional line B-B in FIG. 1.

### DETAILED DESCRIPTION

The present invention will now be described more specifically with reference to the following embodiments and the accompanying drawings. Other advantages and effects of the present invention can be easily understood by a person ordinarily skilled in the art in view of the detailed descriptions and the accompanying drawings. The present invention can be implemented or applied to other different embodiments. Certain aspects of the present invention are not limited by the particular details of the examples illustrated herein. Without departing from the spirit and scope of the present invention, the present invention will have other modifications and changes. It should be understood that the appended drawings are not necessarily drawn to the scale and configuration of each component (e.g., structural designs and sizes of an optical touch module and a monitor) in the drawings is merely illustrative, not presenting an actual condition of the embodiments.

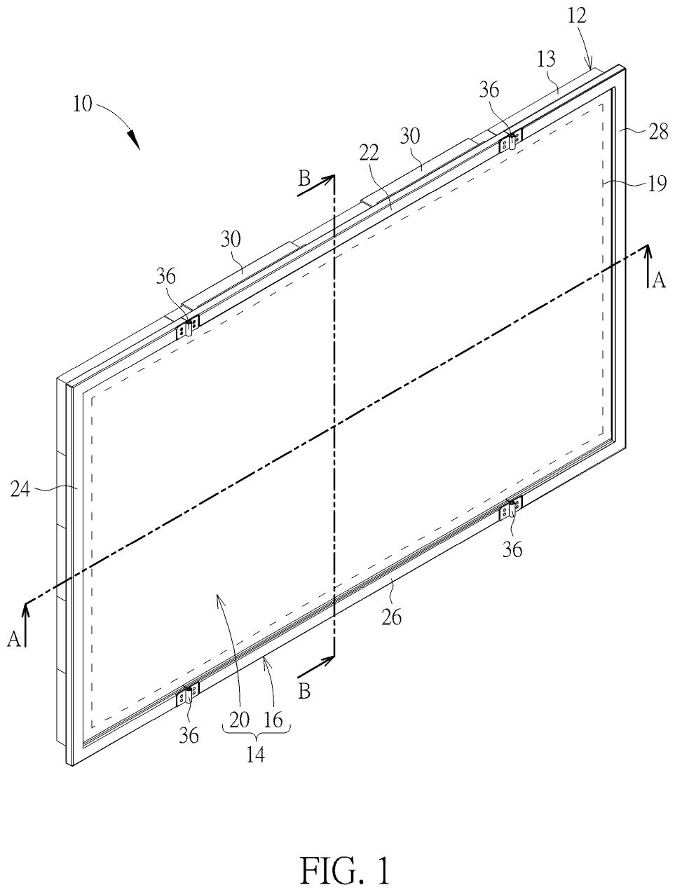

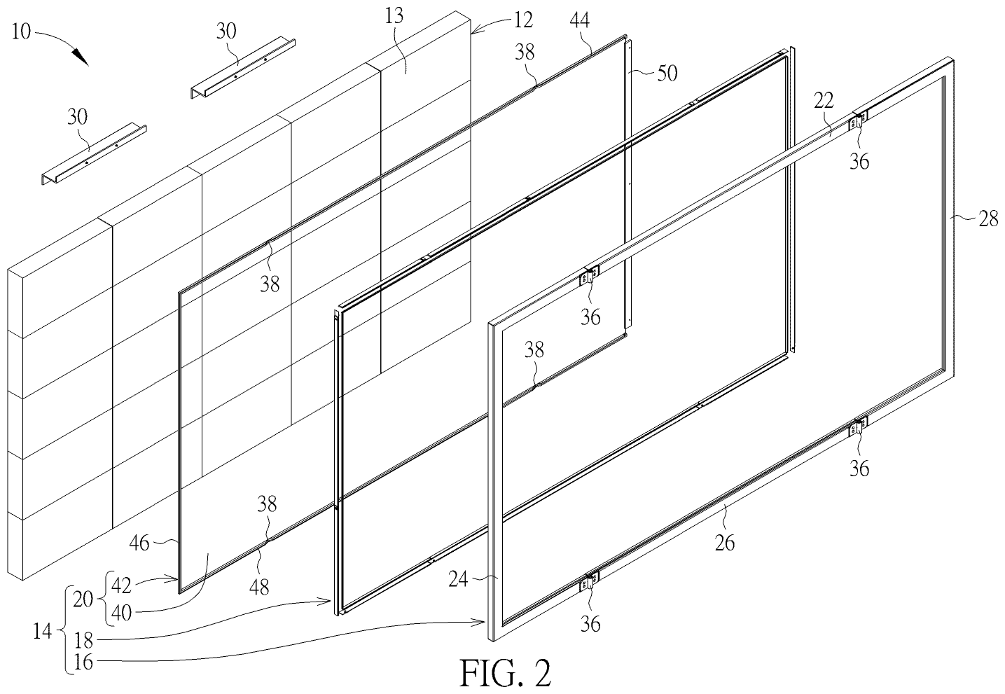

Please refer to FIGS. 1 and 2. FIG. 1 is a diagram of a monitor apparatus 10 according to an embodiment of the present invention. FIG. 2 is an exploded diagram of the monitor apparatus 10 in FIG. 1. As shown in FIGS. 1 and 2, the monitor apparatus 10 includes a monitor 12 and a detachable front frame structure 14. The monitor 12 could be preferably composed of a plurality of spliced screens (e.g., twenty-five spliced screens 13 as shown in FIG. 2, but not limited thereto, meaning that the number of spliced screens could vary depending on the actual application requirements of the monitor apparatus 10). As such, the aforesaid screens spliced side by side can be constructed as a large monitor apparatus. The related description for the splicing design of the monitor 12 is commonly seen in the prior art and omitted here.

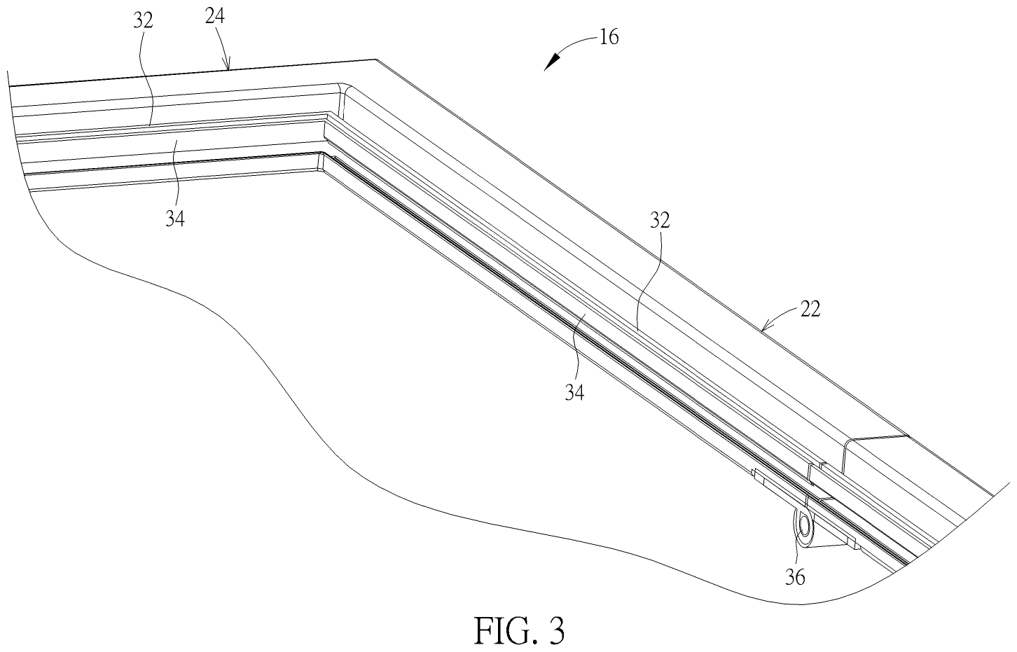

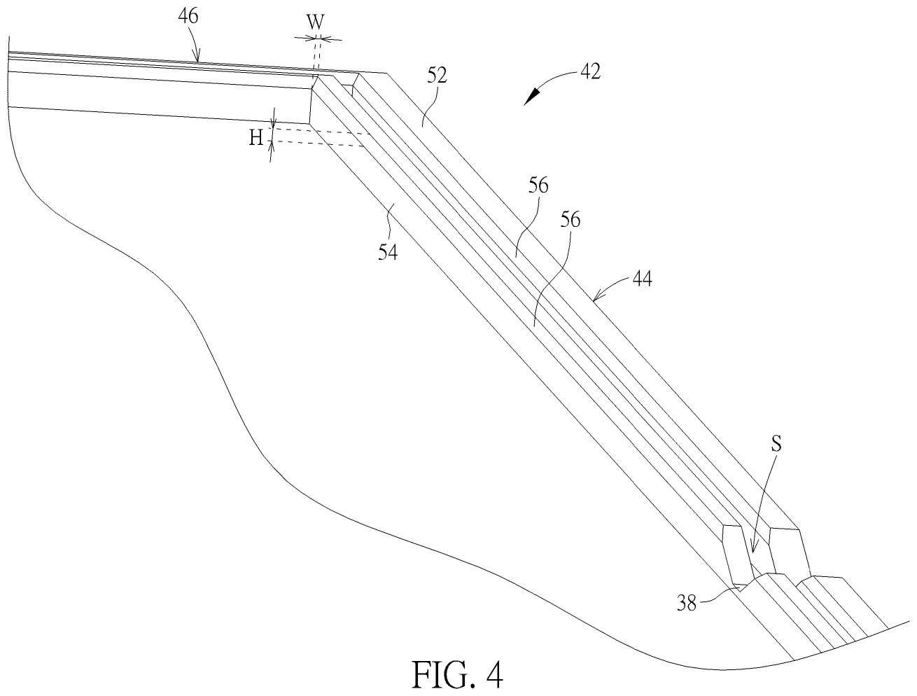

Please refer to FIGS. 1, 2, 3, and 4. FIG. 3 is a partially-enlarged diagram of a front frame 16 in FIG. 2. FIG. 4 is a partially-enlarged diagram of a film frame 42 in FIG. 2. As shown in FIGS. 1-4, the detachable front frame structure 14 accommodates the monitor 12 and serves as a border structure for the monitor 12. The detachable front frame structure 14 includes the front frame 16, an optical touch module 18, and a film component 20. The front frame 16 is detachably mounted on the monitor 12 and has a first top frame 22, a first side frame 24, a first bottom frame 26, and a first connection frame 28. The optical touch module 18 could be preferably an infrared touch module (but not limited thereto, meaning that the present invention could adopt other types of light sources, such as laser light, ultraviolet light, or visible light) and is mounted within the first top frame 22, the first side frame 24, the first bottom frame 26, and the first connection frame 28 to establish a touch sensing area 19 on the monitor 12 (as shown by a dashed area in FIG. 1). This allows a user to perform related optical touch operations, such as cursor movement on the monitor 12. The related description for the component configuration of the optical touch module 18 (e.g., reflection mirrors, light sources, or circuit boards) is commonly seen in the prior art and omitted herein.

To be more specific, in this embodiment, the detachable front frame structure 14 could preferably adopt a clamping detachable design (but not limited thereto, meaning that the present invention could adopt other detachable designs, such as a structural engagement design). For example, as shown in FIGS. 1 and 2, the front frame 16 could further have at least one clamping piece 30 connected to at least one of the first top frame 22 and the first bottom frame 26 (in FIG. 1, two clamping pieces 30 are detachably connected (e.g., via screw locking) to the first top frame 22, but not limited thereto, meaning that the present invention could adopt a double-sided clamping design via the top and bottom frames in another embodiment). In such a manner, the monitor 12 can be detachably clamped to the front frame 16 by clamping between the first top frame 22 and the clamping pieces 30. As for the related description for the clamping structural design of the clamping piece 30 (e.g., the bent clamping piece design shown in FIG. 2) is commonly seen in the prior art and omitted herein. Additionally, as shown in FIGS. 2 and 3, the first top frame 22, the first side frame 24, and the first bottom frame 26 could protrude toward the monitor 12 respectively to form a first outer wall 32 and a first inner wall 34 (the wall design for the first bottom frame 26 could be inferred from FIG. 3). Moreover, the first top frame 22 and first bottom frame 26 could have at least one shaft 36 (in FIG. 2, the first top frame 22 and the first bottom frame 26 each have two shafts 36, but not limited thereto). This allows the first side frame 24 to pivot via the shaft 36 to move away from or toward the monitor 12 for the user to perform subsequent disassembly/assembly operations of the detachable front frame structure 14.

As shown in FIGS. 2 and 4, the film component 20 is disposed between the front frame 16 and the monitor 12 and includes a film 40 and a film frame 42. The film frame 42 has a second top frame 44, a second side frame 46, a second bottom frame 48, and a second connection frame 50 to sequentially surround the film 40. The film 40 could be preferably a PET (Polyethylene Terephthalate) film, but not limited thereto, meaning that the present invention could adopt other materials, such as TPU (Thermoplastic Polyurethane). The film 40 could be preferably accommodated in the film frame 42 by hot-melt connection (but not limited thereto, meaning that the present invention could adopt other connection designs, such as structural clamping or adhesive bonding).

Furthermore, the second connection frame 50 is detachably connected to the first connection frame 28 (preferably by screw locking, but not limited thereto, meaning that the present invention could adopt other common connection methods, such as structural engagement). The second top frame 44, the second side frame 46, and the second bottom frame 48 could protrude toward the front frame 16 respectively to form a second outer wall 52 and a second inner wall 54 for jointly defining a limiting slot S (the wall design for the second bottom frame 48 could be inferred from FIG. 4). The second outer wall 52 and second inner wall 54 respectively form a chamfer structure 56.

To be more specific, in this embodiment, the film frame 42 could preferably adopt a wall-thickness varying design. For example, as shown in FIG. 4, a thickness of the second outer wall 52 could be preferably greater than a thickness of the second inner wall 54 (but not limited thereto, meaning that the present invention could adopt the opposite design in which the thickness of the second outer wall 52 is less than the thickness of the second inner wall 54). The aforesaid design can enhance the structural strength of the film frame 42 via the thicker outer wall and increase the structural elasticity of the second inner wall 54 via the thinner inner wall to avoid interference or jamming issues. To be noted, as shown in FIGS. 2 and 4, the second top frame 44 and the second bottom frame 48 could be formed with an avoiding groove 38 corresponding to the shaft 36 respectively, so as to provide a pivot space required for the first side frame 24, thereby preventing the monitor 12 from being squeezed by the front frame 16 and deformed during pivoting of the first side frame 24 via the shaft 36.

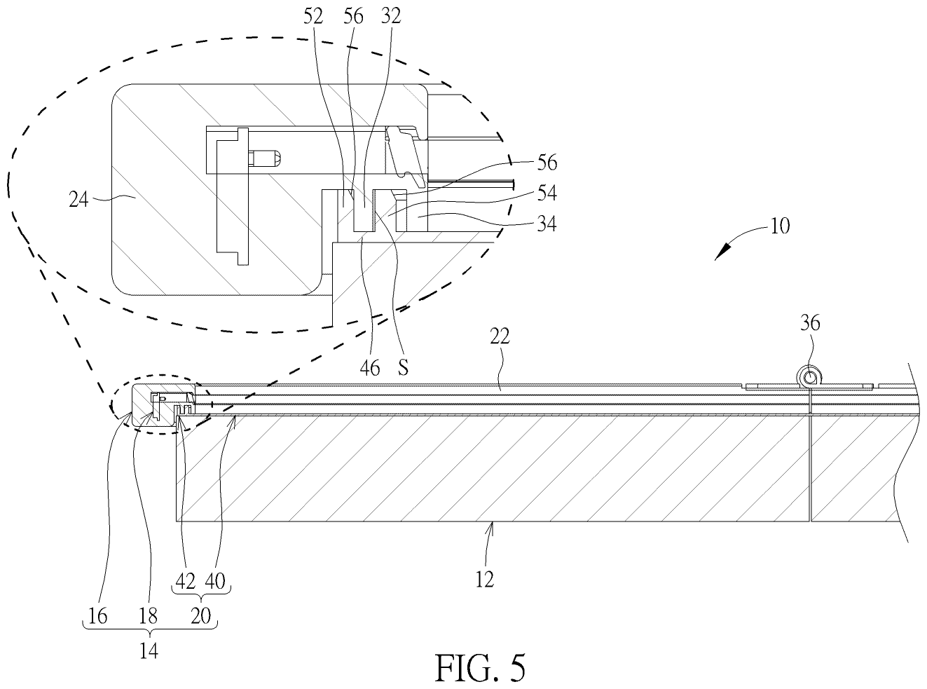

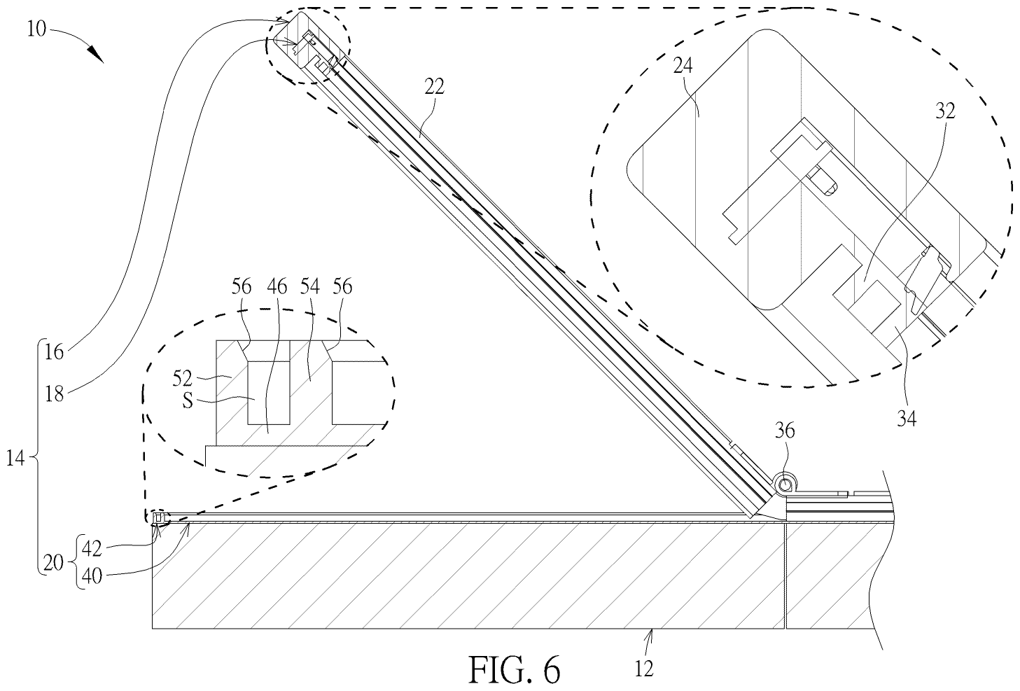

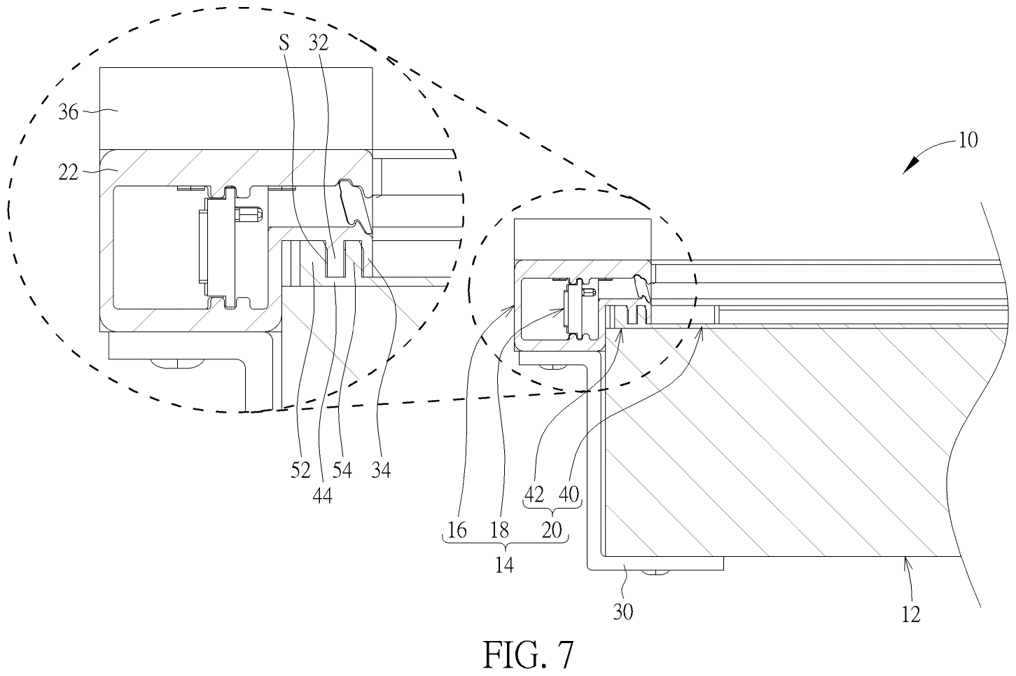

More detailed description for disassembly and assembly of the film 40 in the monitor apparatus 10. Please refer to FIGS. 1, 2, 5, 6, and 7. FIG. 5 is a partial cross-sectional diagram of the monitor apparatus 10 along a cross-sectional line A-A in FIG. 1. FIG. 6 is a partial cross-sectional diagram of the first side frame 24 pivoting away from the monitor 12 via the shaft 36 in FIG. 5. FIG. 7 is a partial cross-sectional diagram of the monitor apparatus 10 along a cross-sectional line B-B in FIG. 1. As shown in FIGS. 1, 2, 5, 6, and 7, when the user wants to perform screen replacement or maintenance operations on the monitor apparatus 10, the user just needs to release connection between the first connection frame 28 of the front frame 16 and the second connection frame 50 of the film frame 42 (e.g., by unscrewing screws with a screwdriver). Next, the user can pivot the first side frame 24 upward from an engaged position shown in FIG. 5 (e.g., pivoting to an expanded position shown in FIG. 6, but not limited thereto). At this time, since the first outer wall 32 and the first inner wall 34 of the first side frame 24 of the front frame 16 have been separated from the second outer wall 52 and the second inner wall 54 of the second side frame 46 of the film frame 42, the structural engagement between the first side frame 24 and the second side frame 46 can be released. As such, via the structural guidance that the first outer wall 32 and the first inner wall 34 of the front frame 16 are engaged with the second outer wall 52 and the second inner wall 54 of the film frame 42 (as shown in FIG. 7, that is, the first outer wall 32 of the first top frame 22 and the first outer wall 32 of the first bottom frame 26 can slide in cooperation with the limiting slot S respectively), the user can fully extract the film frame 42 with the film 40 from the front frame 16 (as shown in FIG. 6). Since the monitor 12 is no longer covered by the film 40, this allows the user to perform subsequent replacement or maintenance operations for the spliced screens 13 on the monitor 12.

On the other hand, after the aforesaid replacement or maintenance operations on the monitor apparatus 10 is completed, the user can align the film frame 42 with the front frame 16 to make the second outer wall 52 and the second inner wall 54 of the film frame 42 engaged with the first outer wall 32 and the first inner wall 34 of the front frame 16 (as shown in FIG. 7, that is, the first outer wall 32 of the first top frame 22 and the first outer wall 32 of the first bottom frame 26 can slide in the limiting slot S respectively). During the aforesaid process, the film frame 42 can slide into the front frame 16 for covering the monitor 12 with the film 40 (as shown in FIG. 6). After the first side frame 28 of the front frame 16 is detachably connected to the second side frame 50 of the film frame 42 (e.g., by screwing), the user just needs to pivot the first side frame 24 downward from an unfolded position as shown in FIG. 6 to the engaged position as shown in FIG. 5, thereby completing the film assembly operation of the monitor apparatus 10. During the aforesaid process, as the first side frame 24 pivots downward, the first outer wall 32 and the first inner wall 34 of the first side frame 24 can first abut against the chamfer structure 56 as shown in FIG. 6, and then respectively generate structural interference with the second outer wall 52 and the second inner wall 54 along the chamfer structures 56, thereby guiding the first outer wall 32 to enter the limiting slot S for generating a limiting engagement effect. At this time, since the first outer wall 32 and the first inner wall 34 still respectively generate structural interference with the second outer wall 52 and the second inner wall 54, the first side frame 24 can push the second side frame 46 of the film frame 42 outward. Additionally, with the engagement between the first top frame 22 and the second top frame 44 (as shown in FIG. 7), the engagement between the first bottom frame 26 and the second bottom frame 46 (could be inferred from FIG. 7), and the frame connection between the first connection frame 28 and the second connection frame 50, the film frame 42 can stretches the film 40 tightly via the second top frame 44, the second side frame 46, the second bottom frame 48, and the second connection frame 50. In such a manner, the film 40 can be smoothly and tightly stretched on the monitor 12 for eliminating any gaps between the spliced screens 13, so as to significantly improve the touch sensitivity for the user performing optical touch operations on the monitor 12.

It should be mentioned that the sliding distance caused by the interference between the first outer and inner walls 32 and 34 and the corresponding chamfer structures 56 for the outward movement of the film frame 42 could be preferably between 0.2 mm and 0.5 mm, so as to effectively enhance the tension and flatness of the film 40. More specifically, in practical experience, a horizontal width W of the chamfer structure 56, as shown in FIG. 4, could be preferably between 0.5 mm and 0.8 mm, and a vertical height H could be preferably between 1 mm and 1.6 mm. However, the size of the chamfer structure may vary depending on the actual application requirements of the monitor apparatus 10, and is not limited to the aforesaid values.

In summary, compared to the prior art where the film is directly adhered to the entire surface of the large monitor apparatus, the present invention utilizes sliding interference between the walls of the film frame and the front frame to allow the film in the film frame to detachably slide into or be extracted from the front frame. In such a manner, if maintenance or replacement of the spliced screens is required, the detachable front frame structure provided by the present invention allows the user to quickly and easily remove the film after simply pivoting the front frame. Thus, the present invention can effectively solve the prior art problem that the repair or replacement process of the large monitor apparatus is time-consuming and strenuous (because the front frame must be completely removed and the film must be torn off before the subsequent processes are performed). Furthermore, the present invention can ensure that the film is tightly and evenly stretched over the display surface for preventing any unevenness of the film, so as to significantly improve the touch sensitivity of the large monitor apparatus and the repair and replacement convenience of the spliced screens.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A detachable front frame structure comprising:
a front frame detachably disposed on a monitor and having a first top frame, a first side frame, a first bottom frame, and a first connection frame in sequential connection, the first top frame, the first side frame, and the first bottom frame protruding toward the monitor to form a first outer wall and a first inner wall respectively, and the first top frame and the first bottom frame having at least one shaft respectively to make the first side frame pivotable away from or close to the monitor via the at least one shaft;
an optical touch module accommodated in the first top frame, the first side frame, the first bottom frame and the first connection frame, for establishing a touch sensing area on the monitor; and
a film component disposed between the front frame and the monitor, the film component comprising:
a film; and
a film frame having a second top frame, a second side frame, a second bottom frame, and a second connection frame in sequential connection to surround the film, the second connection frame being detachably connected to the first connection frame, the first top frame, the first side frame, and the first bottom frame protruding toward the monitor to respectively form a second outer wall and a second inner wall for defining a limiting slot, and the second outer wall and the second inner wall forming a chamfer structure respectively;
wherein when the first side frame pivots away from the monitor, the first outer wall of the first top frame and the first outer wall of the first bottom frame slide in the limiting slot, for allowing the film frame to slide into the front frame or be extracted from the front frame;
when the film frame slides into the front frame and the first side frame pivots toward the monitor, each first outer wall and each first inner wall respectively slide along the corresponding chamfer structure to a position where each first outer wall enters the limiting slot to slide the film frame outward for pulling the film tightly.

2. The detachable front frame structure of claim 1, wherein the second top frame and the second bottom frame respectively form an avoiding groove corresponding to the at least one shaft.

3. The detachable front frame structure of claim 1, wherein the film is accommodated in the film frame by hot-melt connection.

4. The detachable front frame structure of claim 1, wherein the second connection frame is detachably connected to the first connection frame in a screw fastening manner.

5. The detachable front frame structure of claim 1, wherein the front frame further comprises:
at least one clamping piece connected to at least one of the first top frame and the first bottom frame for detachably clamping the monitor to the front frame.

6. The detachable front frame structure of claim 1, wherein thicknesses of the second outer wall and the second inner wall are different from each other.

7. The detachable front frame structure of claim 6, wherein a thickness of the second outer wall is greater than a thickness of the second inner wall.

8. The detachable front frame structure of claim 1, wherein each first outer wall and each first inner wall interfere with the corresponding chamfer structure respectively, so that the film frame slides outward to tighten the film by a distance between 0.2 mm and 0.5 mm.

9. The detachable front frame structure of claim 8, wherein a horizontal width of the chamfer structure is between 0.5 mm and 0.8 mm, and a vertical height of the chamfer structure is between 1 mm and 1.6 mm.

10. A monitor apparatus comprising:
a monitor; and
a detachable front frame structure accommodating the monitor, the detachable front frame structure comprising:
a front frame detachably disposed on the monitor and having a first top frame, a first side frame, a first bottom frame, and a first connection frame in sequential connection, the first top frame, the first side frame, and the first bottom frame protruding toward the monitor to form a first outer wall and a first inner wall respectively, and the first top frame and the first bottom frame having at least one shaft respectively to make the first side frame pivotable away from or close to the monitor via the at least one shaft;
an optical touch module accommodated in the first top frame, the first side frame, the first bottom frame and the first connection frame, for establishing a touch sensing area on the monitor; and
a film component disposed between the front frame and the monitor, the film component comprising:
a film; and
a film frame having a second top frame, a second side frame, a second bottom frame, and a second connection frame in sequential connection to surround the film, the second connection frame being detachably connected to the first connection frame, the first top frame, the first side frame, and the first bottom frame protruding toward the monitor to respectively form a second outer wall and a second inner wall for defining a limiting slot, and the second outer wall and the second inner wall forming a chamfer structure respectively;
wherein when the first side frame pivots away from the monitor, the first outer wall of the first top frame and the first outer wall of the first bottom frame slide in the limiting slot, for allowing the film frame to slide into the front frame or be extracted from the front frame;
when the film frame slides into the front frame and the first side frame pivots toward the monitor, each first outer wall and each first inner wall respectively slide along the corresponding chamfer structure to a position where each first outer wall enters the limiting slot to slide the film frame outward for pulling the film tightly.

11. The monitor apparatus of claim 10, wherein the second top frame and the second bottom frame respectively form an avoiding groove corresponding to the at least one shaft.

12. The monitor apparatus of claim 10, wherein the film is accommodated in the film frame by hot-melt connection.

13. The monitor apparatus of claim 10, wherein the second connection frame is detachably connected to the first connection frame in a screw fastening manner.

14. The monitor apparatus of claim 10, wherein the front frame further comprises:
at least one clamping piece connected to at least one of the first top frame and the first bottom frame for detachably clamping the monitor to the front frame.

15. The monitor apparatus of claim 10, wherein thicknesses of the second outer wall and the second inner wall are different from each other.

16. The monitor apparatus of claim 15, wherein a thickness of the second outer wall is greater than a thickness of the second inner wall.

17. The monitor apparatus of claim 10, wherein each first outer wall and each first inner wall interfere with the corresponding chamfer structure respectively, so that the film frame slides outward to tighten the film by a distance between 0.2 mm and 0.5 mm.

18. The monitor apparatus of claim 17, wherein a horizontal width of the chamfer structure is between 0.5 mm and 0.8 mm, and a vertical height of the chamfer structure is between 1 mm and 1.6 mm.

19. The monitor apparatus of claim 10, wherein the monitor is composed of a plurality of spliced screens.
